(19) United States
(12) Patent Application Publication
(10) Pub. No.: US 2007/0139916 A1
(43) Pub. Date: Jun. 21, 2007

(54) Flashlight with battery life indicator

(76) Inventors: Jordan Vermillion, Overland Park, KS (US); John Cross, Overland Park, KS (US); Scott Nyhart, Shawnee, KS (US)

Correspondence Address: HOVEY WILLIAMS LLP, 2405 GRAND BLVD., SUITE 400, KANSAS CITY, MO, 64108, US

(21) Appl. No.: 11/314,878

(22) Filed: Dec. 21, 2005

(51) Int. Cl. F21L 4/00

(52) U.S. Cl. 362/208; 362/205

(57) ABSTRACT

A flashlight with a battery life indicator to continuously indicate a power level to facilitate flashlight retrieval and battery monitoring is disclosed. The flashlight generally includes a light source, contacts operable to couple with a power source having a power level, an input operable to turn the light source on and off, and an indicator coupled with the power source contacts to continuously indicate the power level. Such continuous indication of the power level enables the flashlight to be easily located in darkness and provides a constant power level reminder to help users maintain the flashlight in operating condition.

### BACKGROUND OF THE INVENTION

1. Field of the Invention

The present invention relates to flashlights. More particularly, the invention relates to a flashlight with a battery life indicator that continuously indicates a power level to facilitate flashlight retrieval and battery monitoring.

2. Description of the Related Art

Flashlights are essential tools in innumerable environments that require illumination of darkened areas, ranging from emergency situations to leisure activities. Unfortunately, users sometimes forget where they have placed their flashlights due to the infrequency in which they are used. Additionally, even if users remember the general location of their flashlights, the users may be unable to locate the flashlights in darkness. Flashlights are also often rendered inoperable due to dead batteries.

To overcome some of these difficulties, flashlights have been developed that include power level indicators, such as indicator lights or power meters. Although such indicators are operable to indicate power levels, they only function when the flashlights are in an “on” position, when the power level is insufficient to illuminate a primary light source, and/or when users selectively operate switches. As should be appreciated, such indicators are of little use if users are unable to locate flashlights in darkness or if users utilize flashlights only in an emergency situations where an indication of a dead battery is of little value.

### SUMMARY OF THE INVENTION

The present invention solves the above-described problems and provides a distinct advance in the art of flashlights. More particularly, the invention provides a flashlight with a battery life indicator that continuously indicates a power level to facilitate flashlight retrieval and battery monitoring. Such continuous indication of the power level enables the flashlight to be easily located in darkness and provides a constant power level reminder to help users maintain the flashlight in operating condition.

In various embodiments, the present invention provides a flashlight comprising a light source, contacts operable to couple with a power source having a power level, an input to turn the light source on and off, and an indicator coupled with the power source contacts. The indicator continuously indicates the power level when the light source is off to facilitate both location of the flashlight in darkness and monitoring of the power level.

The light source and the indicator may each include at least one light-emitting diode to efficiently generate light. The indicator may be integral with the input and indicate the power level by continuously indicating a first color when the power level is high and continuously indicating a second color when the power level is low. The flashlight may further include a housing to house the light source, the contacts, the power source, the input, and the indicator.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a perspective view of a flashlight configured in accordance with various preferred embodiments of the present invention;

FIG. 2 is a rear view of the flashlight of FIG. 1, the flashlight including an integral input and indicator indicating a first power level;

FIG. 3 is a rear view of the flashlight of FIGS. 1-2, the indicator indicating a second power level; and

FIG. 4 is a block diagram of various elements of the flashlight of FIGS. 1-3.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

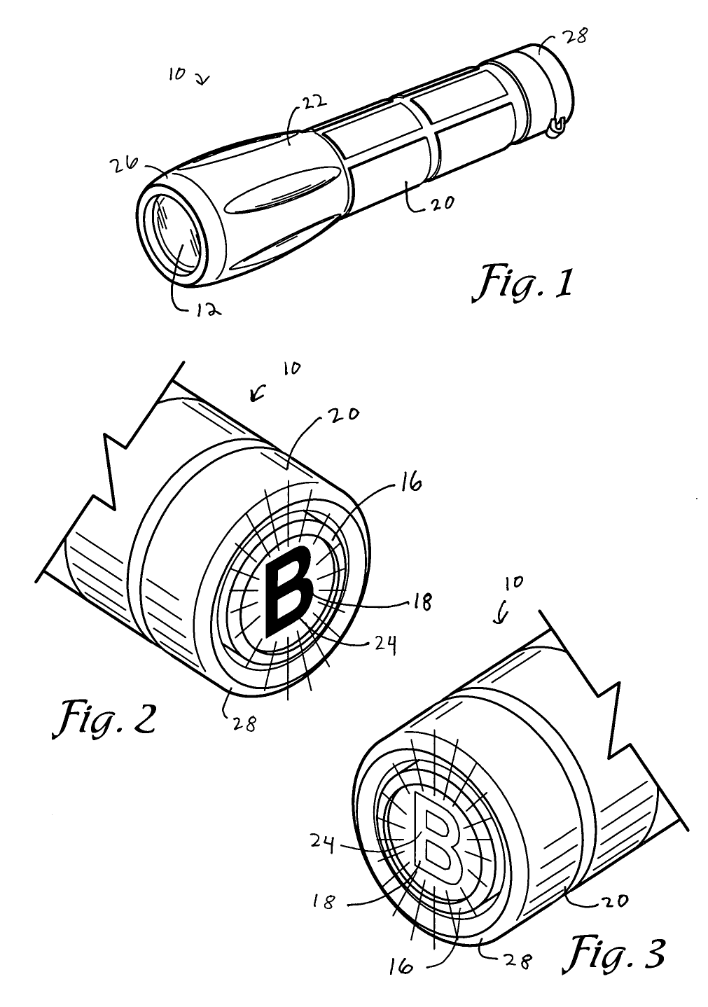

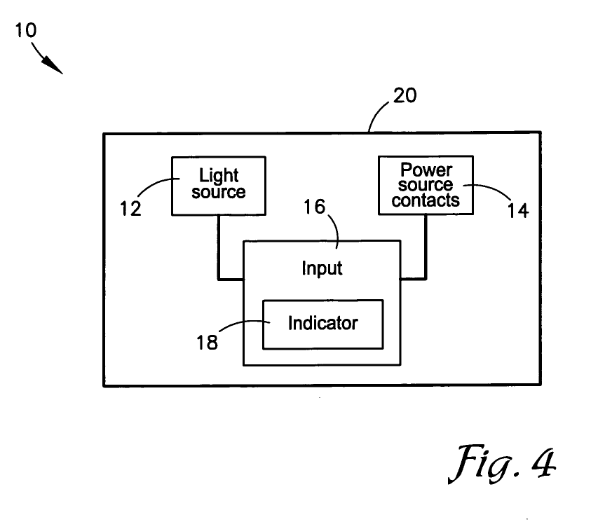

Referring to FIGS. 1-4, a flashlight 10 is shown constructed in accordance with various preferred embodiments of the present invention. The flashlight 10 generally includes a light source 12 operable to provide illumination, contacts 14 for coupling with a power source having a power level, an input 16 coupled with the light source 12 and the contacts 14 to turn the light source 12 on and off, an indicator 18 coupled with the contacts 14 to indicate power level, and a portable housing 20 to house the light source 12, the contacts 14, the power source, the input 16, and the indicator 18.

The light source 12 may be any element that is operable to generate visible or non-visible light of any color or wavelength in response to applied power, such as electricity. Thus, the light source 12 may include conventional optical elements and flashlight bulbs. Preferably, the light source 12 comprises one or more light-emitting diodes (LEDs) to provide low-power, low-heat, efficient, and long-lasting light generation. In various embodiments, the light source 12 may include a single three watt LED providing 100 lumen or more output, such as those commonly manufactured under the trade name “LUXEON” by “LUMILEDS LIGHTING.” However, any light source or combination of light sources, such as a plurality of LEDs, may be utilized by the present invention.

In various embodiments, the light source 12 is operable to provide variable light settings, such as low power, medium power, high power, SOS, and safety strobe settings. The light power settings may be provided utilizing various elements such as filters placed over or in proximity to the light source 12 and/or circuitry coupled with the light source 12 to vary the voltage, current, or other power applied to the light source 12. For instance, the flashlight 10 may include circuitry to provide three different voltage levels to the light source 12 to enable the generation of three different light intensities, etc.

Similarly, the SOS setting, which enables the light source 12 to emit a sequence of pulses corresponding to the international SOS standard, and the safety strobe setting, which rapidly flashes the light source 12 on and off, may be provided by filters placed over or in proximity to the light source 12 and/or circuitry coupled with the light source 12 to vary the voltage, current, or other applied power. For example, the flashlight 10 may include circuitry to rapidly switch power on and off to the light source 12 at predetermined intervals to provide the desired SOS and strobe effects.

The various light settings may be selected utilizing a rotating head 22 that forms a portion of the housing 20. The rotating head 22 is operable to rotate around the housing 20 to enable the selection of low, medium, high, SOS, strobe light, and any other settings. However, the input 16 may also be operable to select the various light settings such that utilization of the rotating head 22 or other elements is not required in all embodiments. The rotating head 22 may also enable the focusing of light generated by the light source 12 in a generally conventional manner to provide wide and narrow beams of light.

The power source provides electrical energy to the flashlight 10 to enable the illumination of the light source 12 and power various other elements such as the indicator 18. The contacts 14 may be any element operable to provide or conduct electrical energy from the power source. Thus, the contacts 14 may include coupling elements for receiving removable or integral batteries, elements for recharging batteries, power connectors such as electrical cables or plugs operable to couple with an electrical outlet, solar and kinetic elements operable to generate energy from light or movement, etc. Preferably, the power source includes two three volt lithium-ion batteries to provide a long-lasting power supply and the contacts 14 include a receptacle for receiving the batteries. The contacts 14 may include a singular contact, such as a single metal element for coupling with the power source or the contacts 14 may include a plurality of elements for coupling with the power source.

The input 16 is coupled with the light source 12 and the contacts 14 to turn the light source on and off. The input 16 may be any element operable to selectivity provide energy from the power source via the contacts 14 to the light source 12, including various functionable switches, latches, circuits, etc. Preferably, the input 16 comprises a depressible switch presenting a generally circular shape that is operable to conduct energy from the contacts 14 to the light source 12 when at least partially depressed. Utilization of the depressible switch may be desirable as it reduces accidental switching of the light source 12 as is common with toggle switches when inadvertently contacted. Further, the positioning of the input 16 on the housing 20, as described below in detail, additionally reduces accidental switching of the light source 12.

The indicator 18 is coupled with the contacts 14 to continuously indicate the power source power level. In some embodiments, the indicator 18 continuously indicates the power level only when the flashlight 10 is off, while in some embodiments the indicator 18 continuously indicates the power level when the device is on and off such that the indication is provided regardless of input 16 position and light source 12 status. The continuos indication provided by the indicator 18 may be an intermediate flashing light or signal that continuously indicates the power level.

The indicator 18 preferably visually indicates the power level utilizing a second light source 24, discrete from the light source 12. The second light source 24 may include any light generating elements operable to generate light of any color and wavelength, but preferably includes a low-power light generating element to conserve energy and prolong power source life. Thus, the second light source 24 may include at least one LED to efficiently indicate power level. Preferably, the second light source 24 includes at least two LEDs to indicate power level utilizing two colors, as described below.

The second light source 24 may be coupled with a decorative grill, transparent window, diffusing mediums, or other optical elements to provide any desired visible effect utilizing light generated by the second light source 24. For instance, the second light source 24 may be positioned behind a decorative logo, as shown in FIGS. 2-3, to aesthetically indicate the power level and facilitate locating the flashlight 10.

The second light source 24 is preferably operable to generate a sufficient light intensity to enable the flashlight 10 to be located in darkened environments, as described below. The intensity of the light generated by the second light source 24 may be sufficient to provide visibility from several feet away, such as from across a room, to assist in power level monitoring and flashlight identification. Utilization of LEDs may be further desirable in some embodiments as they enable minimal power consumption and the generation of light having a sufficient intensity to facilitate location of the flashlight 10.

However, the indicator 18 may include other elements that do not primarily generate light, such as gauges, meters, monitors, etc, to otherwise indicate power level. The indicator 18 may additional include circuitry and other elements to facilitate determination of the power level, such that the second light source 24 need not be directly coupled with the contacts 14 and/or power source. For instance, the indicator 18 may include circuitry to determine when high power and low power conditions exist, as discussed below, by detecting the amount of charge remaining in the power source, detecting the voltage or current provided by the power source, determining the total amount of energy discharged by the power source, utilizing any conventional power monitoring method, or combinations thereof.

The indicator 18 continuously indicates the power level of the power source such that a user need not remember to perform special functions, such as functioning of the input 16, to receive an indication of the power level. Thus, provided the power source includes sufficient energy to power the indicator 18 and/or second light source 24, the indicator 18 may provide an continuous indication of the power level.

Preferably, the indicator 18 is operable to provide varying amounts, degrees, or types of indications in response to varying power levels. For instance, the indicator 18 may provide a first indication, such as a first color or intensity, when the power level is high and the indicator 18 may provide a second indication, such as a second color or intensity, when the power level is low. Preferably, the first color is a positive color such as green and the second color is a negative color such as red to alert the user when the power level is low. As should be appreciated, the indicator 18 is operable to provide innumerable indications corresponding to innumerable power levels, such that the flashlight 10 is not limited to the high power levels and low power levels discussed herein.

In various embodiments, the indicator 18 provides the first color, utilizing the second light source 24, to indicate high power, and provides the second color, also utilizing the second light source 24, to indicate low power. As described above, the second light source 24 may include one or more LEDs to separately generate each color.

The indicated high power generally corresponds to a power level sufficient to provide prolonged use of the flashlight 10 while the indicated low power generally corresponds to a power level insufficient to provide prolonged use of the flashlight 10. Thus, the indicated high power and low power may refer to a power level of 25%, 50%, or 75% of maximum, an estimated power source lifetime, remaining energy amounts, etc,. Preferably, the indicated high power and low power levels correspond to estimated remaining flashlight usage, such that low power is indicated when approximately 20 minutes or less of use remain while high power is indicated for any other remaining usage. Such a configuration may be desirable at it provides the user with sufficient warning to replace or recharge the power source before the flashlight becomes inoperable.

The housing 20 houses at least portions of the light source 12, contacts 14, power source, input 16, and indicator 18 to provide a portable housing for the flashlight 10. The housing 20 may be elongated to present the appearance of a generally conventional flashlight. The housing 20 may be comprised of durable materials, such as aircraft quality aluminum having a hard anodized finish, to enable use of the flashlight 10 in inclement conditions. The housing 20 may also include removable portions to enable the insertion of the power source and comprise various gaskets and seals to render the flashlight 10 substantially waterproof. Additionally, portions of the housing 20 may be rotatable or movable such as the rotating head 22.

The housing 20 includes a generally opposed front 26 and rear 28. The light source 12 is preferably positioned towards the front 26 to facilitate direction of light in a desired direction and the indicator 18 is preferably positioned on the rear 28. In embodiments where the indicator 18 and input 16 are integral, the combination input 16 and integral 18 may be positioned on the rear 28 to reduce inadvertent operation of the flashlight 10. Further, in various embodiments the indicator 18 and/or input 16 may present a circular shape to correspond to shape presented by the rear 28 of the housing 20. Such conformity enables the input 16 to be easily functioned in darkness by applying force to the rear 28 of the housing 20 without requiring specific identification of the input 16.

In operation, the user may utilize the flashlight 10 to perform conventional flashlight functions, such as illuminate darkened areas. Thus, the user may function the input 16 and the rotating head 22 to provide a desired light setting, such as low, medium, high, strobe, etc. The flashlight 10 may then be oriented in the desired direction utilizing the housing 20.

Additionally, the indicator 18 enables the flashlight to be easily located when it is not in use. As described above, the second light source 24 may continuously indicate the power level even when the flashlight 10 is off. The light generated by the second light source 24 or other indicator elements enables the flashlight 10 to always generate light at some interval, independent of the input 16, to enable its identification in darkness or reduced visibility environments. For example, the light generated by the second light source 24 may be utilized to locate the flashlight 10 in a darkened house, a smoke-filled room, in a filled backpack or tent, or in any other situation wherein emitted light may be a useful in finding the flashlight 10. Thus, due to the continuous indication provided by the indicator 18, the flashlight 10 may always be easily located by the user.

The continuous power level indication that is presented by the indicator 18 even when the flashlight 10 is off also provides a constant reminder regarding power level. For instance, each time the user is in proximity to the flashlight 10 the user may view the indicator 18 without having to remember to function the input 16 or other flashlight elements to display the power level indication. Thus, the time required to check the power level is substantially reduced or eliminated by the continuous indication as the user only need to intentionally or unintentionally look at the flashlight 10 to determine power level.

Power level monitoring is also facilitated in embodiments where the indicator 18 utilizes the first color and the second color to indicate the power level. Specifically, the user may easily perceive differences between the first color and the second color, such as green and red, without closely examining the flashlight 10 and/or indicator 18 to determine if the power source has sufficient energy. Thus, the user need not expend a significant amount of time to check the power level, thereby increasing the probability that user will diligently maintain the flashlight 10 in operating condition.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A flashlight comprising:
a light source;
contacts operable to couple with a power source having a power level;
an input coupled with the light source and the power source contacts and operable to turn the light source on and off; and
an indicator coupled with the power source contacts to continuously indicate the power level when the light source is off.

2. The flashlight of claim 1, wherein the indicator continuously indicates the power level when the light source is on and off.

3. The flashlight of claim 1, wherein the light source includes a light-emitting diode.

4. The flashlight of claim 1, wherein the indicator includes a light-emitting diode.

5. The flashlight of claim 1, wherein the indicator continuously indicates a first color when the power level is high and continuously indicates a second color when the power level is low.

6. The flashlight of claim 1, wherein the input and the indicator are integral.

7. The flashlight of claim 1, wherein the contacts are operable to couple with a battery.

8. The flashlight of claim 1, further including a portable handheld housing to house the light source, the input, the power source contacts, and the indicator.

9. A flashlight comprising:
a light source;
contacts operable to couple with a power source including a battery having a power level;
an input coupled with the light source and the power source contacts and operable to turn the light source on and off; and
an indicator coupled with the power source contacts including a light emitting diode to continuously indicate a first color when the power level is high and continuously indicate a second color when the power level is low.

10. The flashlight of claim 9, wherein the light source includes a light-emitting diode.

11. The flashlight of claim 9, wherein the input and the indicator are integral.

12. The flashlight of claim 9, further including a portable handheld housing to house the light source, the input, the power source contacts, and the indicator.

13. The flashlight of claim 12, wherein the housing includes a front and a rear, and the light source is positioned towards the front of the housing and the indicator is positioned on the rear of the housing.

14. The flashlight of claim 9, wherein the power source contacts are operable to recharge the battery.

15. A flashlight comprising:
a light source including a first light emitting diode;
contacts operable to couple with a power source including a battery having a power level;
an input coupled with the light source and the power source contacts and operable to turn the light source on and off;
an indicator integral with the input, coupled with the power source contacts, and including a second light emitting diode to continuously indicate a first color when the power level is high and continuously indicate a second color when the power level is low; and
a portable handheld housing to house the light source, the input, the power source contacts, and the indicator, the housing including a front and a rear, the light source being positioned towards the front and the input and the indicator being positioned on the rear.

16. The flashlight of claim 15, wherein the input comprises a depressible switch.

17. The flashlight of claim 15, wherein the power source contacts are operable to recharge the battery.
